(19) United States
(12) Patent Application Publication
(10) Pub. No.: US 2014/0244699 A1
(43) Pub. Date: Aug. 28, 2014

(54) Apparatus and Methods for Selective Location and Duplication of Relevant Data

(71) Applicant: Jonathan GRIER, Lakewood, NJ (US)

(72) Inventor: Jonathan GRIER, Lakewood, NJ (US)

(21) Appl. No.: 14/253,129

(22) Filed: Apr. 15, 2014

Related U.S. Application Data
(63) Continuation-in-part of application No. 14/059,410, filed on Oct. 21, 2013.
(60) Provisional application No. 61/769,606, filed on Feb. 26, 2013.

(51) Int. Cl. G06F 17/30

(52) U.S. Cl. CPC G06F 17/30091
USPC 707/822

(57) ABSTRACT

Apparatus and methods are provided for performing a digital forensic investigation. Aspects of the apparatus and methods determine the location of forensically relevant data on a data source and copy this relevant data to a storage device in a forensically sound manner. Information related to the location of the relevant data may also be stored on the storage device.

### CROSS REFERENCE TO RELATED APPLICATIONS

This application is a continuation-in-part of U.S. patent application Ser. No. 14/059,410 (the '410 application) entitled “Apparatus and Methods for Selective Location and Duplication of Relevant Data”, which was filed on Oct. 21, 2013 and which claims the benefit of the filing date of U.S. provisional patent application No. 61/769,606 entitled “Apparatus and Methods for Selective Location and Duplication of Relevant Data”, which was filed on Feb. 26, 2013, by the same inventor of this application. Both the utility application and the provisional application are hereby incorporated by reference as if fully set forth herein.

### FIELD OF THE INVENTION

The invention relates generally to copying of electronic data and more particularly to apparatus and methods for selectively locating and replicating, in a forensically sound manner, relevant data from a data source.

### BACKGROUND OF THE INVENTION

A digital forensic investigation is an investigation of a digital source (also referred to herein as a “storage device” or “data source”) such as a computer, computer peripheral, video camera, still image camera, smartphone, video gaming device, network, network device, hard-drive, floppy disk, CD, DVD), nonvolatile memory (Flash, USB drive, thumb drive, built-in Flash), volatile memory (RAM), or any other digital storage device to determine the state of and/or events related to the data, using procedures and techniques which allow the results to be entered into evidence in a court of law. Typical applications of digital forensic investigations include law enforcement investigations, electronic discovery (e-discovery) in civil cases, incident responses such as to data theft, etc.

A digital forensic investigation typically begins with receipt of an assignment and a determination of which data/information the investigator is being charged with finding. In other words, the investigator is informed and/or can determine from experience what information will be “relevant” to an investigation. Since different investigations may have different objectives and/or requirements, information that is relevant in one investigation may or may not be relevant in another investigation. Relevance is thus specific to an investigation. Relevance may also be a relative concept such that data may fall within a range somewhere between completely irrelevant and very relevant to a specific issue or sub-issue.

The next step in a conventional digital forensic investigation is imaging: the investigator makes a bit-for-bit copy of the entire data source (including relevant, irrelevant and empty data) in a forensically sound manner. The image is guaranteed to be an identical duplicate, without modification, of the original system, in a form which can be analyzed and investigated. Conventional imaging is done using existing, specialized hardware and software (e.g. forensic duplicators, forensic bridges, forensic write blockers and imaging software).

Recent technology trends have caused a surge in the number and storage capacity of data sources, however, the speed of imaging devices has not kept pace with the increased capacity. As a consequence of this imbalance, the amount of time required to create a forensic image has been growing to a point where it is becoming impractical.

In view of the foregoing it would be advantageous to provide methods for improving the speed of a digital forensic investigation. It would also be advantageous, when imaging a data source, to take into account the relevance of the data being imaged. It would be advantageous to provide apparatus for performing efficient forensic digital investigations. It would also be advantageous, to provide apparatus for performing forensic digital investigations which takes into account the relevance of the data being imaged.

### BRIEF SUMMARY OF THE INVENTION

Many advantages will be determined and are attained by the invention, which in a broadest sense provides apparatus and methods for duplicating, in a forensically sound manner, data from a storage device. Aspects of the invention provide methods and apparatus which examine a data source, locate relevant data and copy the relevant data and information associated with the relevant data to a storage device using forensically sound techniques, thus converting the data source into a data source of relevant data. Aspects of the invention provide locating metadata on the data source, analyzing the metadata to locate data that is relevant to a particular circumstance, and storing the relevant data onto a storage device along with the associated metadata. Optionally, a hash function is also created for confirming the accuracy and integrity of the data on the storage device. Implementations of the invention may provide one or more of the features disclosed below.

One or more embodiments of the invention provide(s) a method for imaging a data source in a forensically sound manner. The method includes a secondary device selectively communicating with the data source; identifying data stored on the data source, wherein the data indicates additional data stored on the data source; parsing the data, analyzing the parsed data to identify the highest sector number that is allocated data, and copying that sector and all sectors with a lower sector number to a storage device associated with the secondary device.

One or more embodiments of the invention provide(s) a method for imaging a data source, wherein the data source is divided into sectors. The sectors are allocated according to an order of storage. The method includes a device selectively communicating with the data source. The device determines that at least one of the sectors on the data source has been allocated. The device further determines that at least one sector on the data source has never been allocated. The device identifies as relevant the at least one allocated sector and at least one sector which precedes, in the order of storage, the at least one allocated sector. The device identifies as irrelevant the sector that has never been allocated.

One or more embodiments of the invention provide(s) a method for imaging a data source, wherein the data source is divided into sectors. The sectors are allocated according to an order of storage. The method includes a device selectively communicating with the data source. The device determines that at least one of the sectors on the data source has been allocated. The device further determines that at least one sector on the data source has never been allocated. The device copies, to a storage associated with the device, the at least one allocated sector and at least one sector which precedes, in the order of storage, the at least one allocated sector. The device does not copy the sector that has never been allocated.

One or more embodiments of the invention provide(s) a method for performing a forensic investigation of a data source. The data source is divided into sectors and the sectors are allocated according to an order of storage. The method includes a device selectively communicating with the data source, determining that at least one sector has been allocated and determining that at least one sector has never been allocated. The device also identifies as relevant the at least one allocated sector and identifies as irrelevant the sector(s) that has/have never been allocated.

One or more embodiments of the invention provide(s) an apparatus for performing a forensic investigation of a data source, wherein the data source is divided into sectors and wherein the sectors are allocated according to an order of storage. The apparatus includes a processor configured to selectively communicate with the data source and configured to determine that at least one sector is allocated. The processor is also configured to determine that at least one sector has never been allocated. The processor is configured to identify as relevant the allocated sector(s) and to identify as irrelevant the sector(s) that has/have never been allocated.

### BRIEF DESCRIPTION OF THE DRAWINGS

For a better understanding of the invention, reference is made to the following description and examples, taken in conjunction with the accompanying drawings, in which like reference characters refer to like parts throughout, and in which:

FIG. 1 is a flow chart of a method of performing a digital forensic investigation in accordance with one or more embodiments of the invention.

FIGS. 1a-1b are flow charts of additional methods of performing a digital forensic investigation in accordance with one or more embodiments of the invention.

FIG. 2 is a diagram of a forensic imaging device in accordance with one or more embodiments of the invention.

FIG. 3 is a diagram of a digital data source in accordance with one or more embodiments of the invention.

The invention will next be described in connection with certain illustrated embodiments, examples and practices. However, it will be clear to those skilled in the art that various modifications, additions, and subtractions can be made without departing from the spirit or scope of the claims.

### DETAILED DESCRIPTION OF THE INVENTION

Apparatus and methods are provided for imaging a digital data source to create a forensically sound copy/duplicate/replica/image (these terms are used interchangeably herein). A forensically sound duplicate includes the information needed to perform low level forensic analysis of the data, recover deleted or slack data, analyze file system metadata and timelines, and perform other types of digital forensic analysis and store it on a storage device. While the data source can be any digital data source, for ease of explanation the following description will be limited to a computer hard-drive. However, those skilled in the art will recognize that the invention is not so limited and the description may be easily adapted for other devices and understood by those skilled in the art.

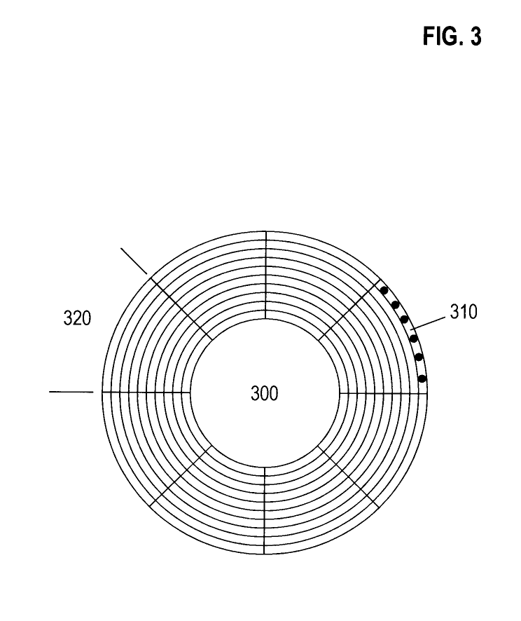

A typical data source, such as a computer hard-drive (as illustrated in FIG. 3), stores metadata (data that provides information about other data), email files, executable files, document files, unused data (typically a sequence of binary 0's or bytes for which the file system has no knowledge of their actions) and various other file and data formats. For purposes herein, a reference to “data” that is identified and/or located may be deemed to refer to metadata and/or a file containing data and/or data stored in a format other than a file, whichever is more appropriate for the reference and whichever provides the broader scope for the reference but does not cause the reference to be rendered obvious by existing references or ambiguous. One or more aspects of the invention limit(s) the imaging to relevant data stored on the data source. This may be achieved by identifying and/or locating, accessing and analyzing metadata and using the metadata to find additional data that is relevant to the investigation, then duplicating and storing the metadata, the relevant additional data and additional data that is deemed to be relevant. It may also or alternatively include parsing a file and learning from the parsed file the location and/or identification of additional data. For purposes herein, a reference to “file” may be deemed to refer to a conventional file format or any group of data that is associated together for a common meaning or purpose, whichever is more appropriate for the reference and whichever provides the broader scope for the reference but does not cause the reference to be rendered obvious by existing references or ambiguous.

Relevance: As previously discussed relevance may be specific to a particular investigation or a particular set of circumstances. Relevance also need not be absolute (i.e. there can be different levels or degrees or probabilities that something is relevant). Thus regions may be prioritized based on their degree of relevance with high priority regions being imaged before low priority regions. Additionally, the priority levels may be recorded to aid in subsequent paring down of the image and/or to provide an audit trail.

Criteria for determining forensic relevance may need to be configured for each duplication effort. Often the criteria may be configurable based on parameters, fields, predicates, mathematical expressions, algebraic expression, file name(s), file path(s), file extension(s), file properties, file type(s), MIME type(s) and string regular expressions. Additionally or alternatively, all information read by an investigator, or automated software or hardware monitoring tools may be considered relevant and thus duplicated. The examiner could mark types of files or specific files as relevant or not, etc. External sources may be used to determine relevance (e.g. the memory may first be analyzed forensically, and that may be fed into the device and used to determine relevance). A device or method configured in accordance with one or more embodiments of the invention may be configured to collect everything except that which is deemed irrelevant. Alternatively, it could be configured to only collect that which is deemed relevant. The difference between these two approaches relates to how items are processed when there is uncertainty about the relevance.

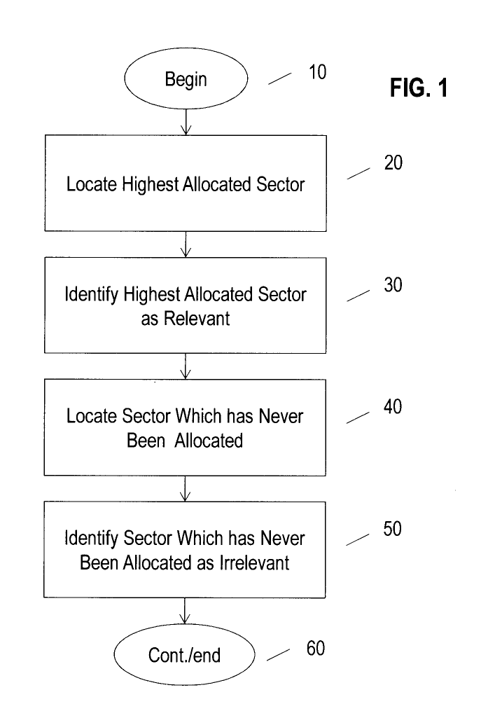

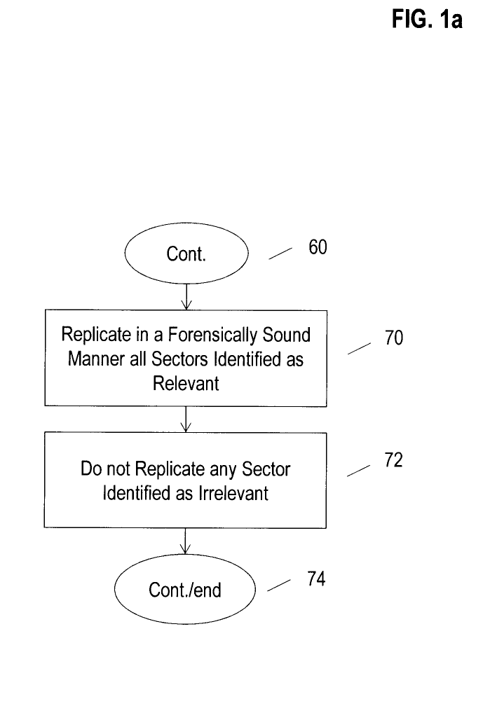

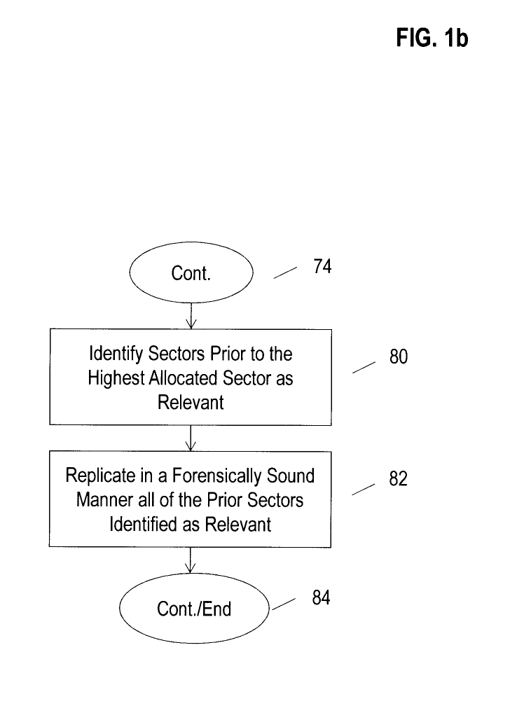

One or more aspects of the invention attempt(s) to collect everything within the data source (FIG. 3—300) except that which is deemed irrelevant. One of various possible ways to accomplish this (as illustrated in FIGS. 1, 1a and 1b) is to duplicate parts of the disk that have been allocated (used to store current or deleted data)(FIG. 1a—70), and to not duplicate parts of the disk that may not have ever been allocated (never used to store data) (FIG. 1a—72). In some instances, the metadata present in the device will explicitly indicate the state of various sectors (a sector can be a block of data, a range of bytes, or any other unit for separating the data source into smaller units)(FIG. 3—310) or regions (groups of sectors)(FIG. 3—320). For example, the new technology file system (NTFS) $Bitmap file, in conjunction with other volume and NTFS metadata, indicates sectors that are currently allocated (“State 1”). The NTFS Master File Table (MFT) in conjunction with other volume and NTFS metadata indicate sectors that are in State 1, and sometimes indicate sectors that were previously allocated (“State 2”). This NTFS data may be parsed using conventional techniques.

In some instances, the hardware or device itself will contain such metadata. For example, Flash drives routinely store the allocation status of different regions of the drive, to enable wear leveling and error correction and other benefits. In these cases, the device can simply query and parse this metadata to determine allocation status.

However, in some instances, metadata indicating allocation status is incomplete or unavailable or not in a known format. Depending on the design choice these regions can be deemed relevant or irrelevant. For example if the image is to support file carving (i.e. reconstruction of files whose data is present but whose metadata is deleted) sectors that are likely to have data, but which are lacking metadata are identified and their regions are deemed relevant. Other techniques may be employed to determine relevance. Metadata is typically available to determine which sectors are in State 1. However, information is not always available to determine which sectors are in State 2 versus which sectors have never been allocated (“State 3”). Metadata often does not distinguish the two. However, sectors are normally allocated in order (referred to herein as the order of storage). Thus, if it can be determined that a sector X is either in State 1 or State 2 (FIG. 1—20) then it can be assumed that every sector <X is in State 1 or State 2 (FIG. 1b—80). Further if it can be determined that X is the highest numbered sector in State 1 or State 2 (FIG. 1—20) then it can also be assumed that every sector >X is in State 3 (with certain exceptions which will be discussed herein)(FIG. 1—40, 50). Therefore, the device may duplicate all sectors through Sector X (FIG. 1a—70, FIG. 1b—82), but not duplicate any sector higher than Sector X (FIG. 1a—72).

In one or more embodiments, the device may be configured to add a margin of error. For example, if it is definitively determined that Sector X is the highest sector in State 1 or State 2 and if Sectors X+1 through Sector X+k may be in State 2 but there is a question, then these sectors X+1 though X+k may be duplicated as well. The value of k may be a constant, or it may vary based on the disk size, or other statistical properties of the disk, the data, the filesystem, or the metadata.

The device may also or alternatively perform sampling of the sectors (using binary search, random samples, or other algorithms). If the data in a sampled sector contains anything other than the factory default (which is usually binary NULLs) that indicates that the sector is not in State 3. Conversely, if the data in a sector is the factory default, it may indicate that the sector is in State 3. Consequently, by sampling individual sectors, the device may determine which sectors or regions are likely to be in which allocation state. Additionally, the device may sample sectors with sector numbers that are larger than the expected largest sector number of the disk in the off chance that the disk is larger than expected.

Those skilled in the art will recognize that these methods can be used recursively and in repeated combination with each other. For example, the device may use metadata to determine that Sectors 0 to X are in State 1 or State 2, then sample sectors >X to determine that Sectors X to Y (where Y>X) may be expected to also be in State 1 or State 2. Optionally, a margin of error is then added. Assuming that sectors 0 to Y+k may be in State 1 or State 2, then perform additional sampling to determine additional sectors that may be in State 1 or State 2, repeating any or all of the steps as needed or desired.

There may be times when sectors are used out of order (i.e. the order of storage is not sequential from sector 0 or 1, depending on the numbering scheme, though sector X; where X is the last sector of the data source). For example, NTFS will often store a backup copy of the MFT ($MFTMirr) in the middle of the storage device. One or more embodiments of the invention may have explicit knowledge of these situations, and compensate for them. For example, one or more embodiments may determine that if sector A is allocated, every sector <A is presumed to be in State 1 or State 2, unless sector A is in use by data, such as $MFTMirr, which is typically allocated out of order. Likewise, the ext3 filesystem places certain critical metadata throughout the disk, allocating these sectors out of order. The device may contain this knowledge and process accordingly, as described. These known files of metadata may be duplicated and stored together with the rest of the duplicated data, stored separately or not duplicated.

An alternative to assuming that if Sector X is in State 1 or State 2 then all sectors <X are also in one of those states, one or more embodiments may assume that any Sector within a certain proximity “d” to a sector X that is in State 1 or State 2 is also in a similar state (similar to the above described margin of error). For example, as an alternative, if it is determined that Sector X is in State 1 or State 2 then sectors X-d through X+d will also be in State 1 or State 2. The value of d may be fixed, but may also depend on the device, the data, the filesystem, and/or their statistical properties. For example, if large regions are found to be allocated (State 1 or State 2), d should be large, whereas if only small regions are found to be allocated (State 1 or State 2), then d should be small.

In one or more embodiments the invention may incorporate more detailed knowledge of the algorithm and scheme by which sectors on the disk and/or filesystem are used (i.e. the order of storage), and, by reversing that algorithm, may determine likely allocation states of different regions. By way of a non-limiting example, a filesystem has the property that it first allocates sectors 1-1000, then sectors 5000-6000, then sectors 1001-4999, then sectors 6001 to the end of the disk. The invention determines either from the filesystem metadata or by sampling that sector 1200 is in State 1 or State 2. As a result, the device identifies sectors 1-1000, 5000-6000 and 1001-1200 as being in State 1 or State 2 based on its knowledge of the allocation algorithm. The device then duplicates at least sectors 1-1000, 5000-6000 and 1001-1200.

In addition to or alternatively, an investigator could be allowed to manually examine the system, or run automated hardware or software tools. The tools employed for manual or automated examination may be incorporated into the invention or tools employed in conjunction with the invention. One or more embodiments of the invention may then monitor the regions of the disk that are read. Anything that the investigator and/or the tool(s) read(s) can be considered relevant and thus duplicated. This can be done in parallel, serially, at entirely different times or instead of other methods. By way of a non-limiting example, one or more embodiments of the invention run(s) a conventional triage tool, such as osTriage, or ADF, and monitor(s) the regions of the disk that are read. All of these regions are then duplicated. By way of another example, one or more embodiments allow(s) an investigator to inspect a storage device. This can be done locally, using live forensics tools, or remotely, using tools like F-Response or EnCase Enterprise. The one or more embodiment(s) monitor(s) all sectors/regions of the disk that are read and duplicates them.

A possible technique for implementing the above approach is to create a virtual device, which acts as an interface to the disk but also monitors all reads done through the virtual device. It then duplicates all read regions. It may be useful for the virtual device to ignore or reject write commands. By way of a non-limiting example, suppose there is a source disk, and an operating system, such as Windows™ or Linux™, which has the ability to read the source disk. There is also software, such as a device driver, which creates a virtual disk, which the operating system presents as another disk. This software allows the operating system and applications to read the virtual disk. When a read command is received, the software reads the corresponding data from the source disk and duplicates the data (and typically/optionally the surrounding region). When a write command is received, it is either executed, ignored or it may generate an error. Optionally, multiple virtual disks may be created, with different behaviors for each. For example, the software may give priority to read requests done to one virtual disk over requests to other virtual disks. Optionally, when a read request is received for data in a location that has already been duplicated, the software returns the duplicated data instead of the original data. Thus, the duplication may act as a cache. Alternatively, read requests may be done normally regardless of the number of times data in the same location is read. One or more embodiments will monitor these requests (e.g. by hooking the operating system or device driver), keep track of and duplicate the sectors that are read.

While it is useful to store a partial image in a file (or some other appropriate storage format), an association between data and its location on the source device should also be preserved for a forensically sound copy. In one or more embodiments, instead of storing sector numbers and data at the granularity of individual sectors, pages of multiple sectors (regions) are stored together. For instance, a page of 32,768 sectors may be stored together as one unit. In this case, instead of storing the sector number of each sector in a page, it suffices to store the sector number of the first sector in the page. Given any sector number x, the sector number of the first sector in x's page may be computed by setting x's 15 least significant bits to zero (e.g. if the page size is 32,768=2̂15 sectors). This may improve speed in some embodiments, both by reducing the memory required and by retrieving data from the data source more efficiently. Storing entire pages also allows a simpler and more compact storage format, and may be of forensic benefit as well (e.g. since relevant data is typically stored in proximity to other relevant data, by copying entire pages relevant data that otherwise may not have been duplicated may be duplicated). Pages for regions that for one reason or another were not copied to the image may be omitted or otherwise marked as absent. Alternatively, a page of null or dummy data, or another type of dummy page, can be used for omitted regions. Each omitted region may have its own null or dummy page, or one page can be used for multiple omitted regions.

Not all regions will necessarily be stored at the same time. The file may be formatted to facilitate efficiently adding regions. This may be achieved by allowing regions to be stored out of order (e.g. new regions may be appended to the end of the file—regardless of their location on the source disk). To facilitate out of order storage of regions an index or table of contents (TOC) of regions may be employed. The index or TOC stores an association between locations on the disk and pages within the file. These pages can thus be stored in the file in any order. New pages can be added by appending them to the end of the file, and updating the index or TOC. Additional metadata about each region (e.g. the prioritized relevance of the region, and the time of its collection) can be stored as well.

A non-limiting example of storing pages would be to use the Advanced Forensics Format (AFF), with each AFF page corresponding to a region of the source disk, with regions of the source disk that are absent from the image having their corresponding page omitted from the index/TOC and the file, and with metadata stored in special dedicated segments (e.g. a segment containing a Region Map of highly relevant regions, and a segment containing a Region Map of moderately relevant regions).

One or more of the above duplicate drives (images) may be reduplicated and/or further pared down using features disclosed in the '410 application. Images (both full and partial) tend to take up a lot of storage space and they may contain information or data that is off limits (e.g. attorney confidential) or otherwise undesirable. In such instances it may be useful to remove the unwanted data from the duplicate drive by creating a forensically sound duplicate of the duplicate which excludes regions, or sectors (or some other category depending upon the desired granularity) that are unwanted. Additionally or alternatively, the duplicated drive may be duplicated again (one or more times) using profiles, operator interaction/decisions, whitelists, blacklists or any other automated process to determine which of the already duplicated data is “relevant” for the further duplication and then only duplicate the relevant data for that duplication. If the format permits, it may be possible to simply delete the unwanted data from the existing image. Likewise, if the original media is still available, additional regions that were not originally duplicated, may be added either by reduplicating or by adding to the file if the format permits. By way of a non-limiting example, suppose the police seize a data source. An examiner determines, believes or is informed that the only information that will be relevant on the data source will be emails. The examiner then duplicates all regions of the data source containing emails. As the case progresses, it is determined that that audio files may also be relevant. All regions from the data source that contain audio files are then added to the image, either by adding to the original image file or by reduplicating and making a new image file with both the contents of the first image and the regions containing audio files.

Data Collection:

Many data sources have known locations where they store metadata, which can be expected to be relevant. Thus, during data collection metadata is located and temporarily stored (e.g. in a stack, queue, memory, storage, etc.) then analyzed to determine the location of additional relevant data for duplication. Metadata (e.g. Master Boot Record, partition tables, partition maps, disk label, filesystem metadata, File Allocation Table (FAT), FAT Boot Sector, FAT32 FSINFO, directory files, New Technology File System (NTFS) Master File Table (MFT), MFT entries, $MFT File, $MFTMirr file, $Boot file, $Volume file, $Bitmap file, directory indexes, filesystem journals, etc.) are identified/located (e.g. by one or more device level identifiers such as location, sector number, block number, byte number, file path, file name, memory address, URL or any other device level identifier where the device may be queried for the particular identifier) retrieved, parsed and analyzed.

Typically the metadata will provide the location and characteristics of other data (e.g. metadata may identify, among other things, sector status—currently in use, deleted, never used, file name, creation date, file type, data type, whether the file was deleted or not, date of deletion, whether data is part of a file, whether data has been used or is irrelevant, dates of usage, size, encryption, owner, creator, etc.) that is stored on the data source. In those instances, the metadata is analyzed, and from analyzing the metadata, it is determined if the other data is relevant. If the other data is not relevant, the time required to retrieve it may be avoided. Additionally, or alternatively, some or all data may be read to determine whether or not it is relevant. If it is not relevant it may be omitted. While this may be more time consuming it is more accurate and may speed up analysis. Instead of omitting or avoiding it, one or more embodiments store data indicating that the region is deemed irrelevant such as in a Region Map. Likewise, one or more embodiments store a description of the region; in some cases, this may completely describe, or provide enough information to fully reconstruct, the region's data. Data may be deemed irrelevant for any number of reasons. By way of a non-limiting example, the device may have access to a database of hashes of known irrelevant data, sectors and/or regions (These hashes are not necessarily of entire files.), and compute a hash as it reads the storage device. If the hash of the data, sector or region matches the database, it is deemed irrelevant. If the data is all binary NULLs, it may be deemed irrelevant. If the data is constant, or of low entropy, it may be deemed irrelevant. In some cases, the hash or some other identifier may be stored instead, or a reference to the database may be stored; this allows future determination of the contents of the data, sector or region.

Other times, the metadata or file will provide the location of additional metadata and/or file(s). In those instances, the additional metadata and/or files may be retrieved, parsed and analyzed as was the original metadata/file. This iterative process may continue until no additional metadata/file is located or it may be terminated at a point prior to such time. Those skilled in the art will recognize that the decision when to terminate is a design choice.

Selective Storage:

When the relevant data is identified, duplicated and stored, the location/identifier that the data had in the data source is also stored. This location is stored in metadata which is stored in a manner associated with the copied data. The location or identifier should be sufficient to unambiguously retrieve the data from the storage device. It should also be sufficient to unambiguously assert the state of, at least some of, the device's data at the time of collection. So, in addition to, for example, recording a sector number, it should record that sector's contents, and associate them with that sector number. Typical identifiers include sector number, block number, byte number, or memory address, and depend on the data source. Other identifiers include file path and file name, or URL. Preferably the stored location includes sufficient information to retrieve the data from the storage device without the need for the iterative process performed on the data source. Storing a sector number typically suffices for this purpose in most hard-drives. The location is likewise typically expressed in a format that the storage device can natively and unambiguously retrieve (e.g. sector number). However, the location need not be stored explicitly, as long as sufficient information is stored which allows unambiguously calculating or determining the location. For example, instead of storing a sector number, it may suffice to store a “sector group” or “region” number along with the number of sectors which make up one sector group/region; likewise, it may suffice to simply store sector data in a specified order allowing inference of the sector number based on position of that sector's data.

Preferably the duplicated data is stored in the storage device in the same format (or in a compressed format—so long as the decompression algorithm is well established) that it is stored in the data source—or returned by the data source (the data source may store it in one format, but return it over its interface in a different one; depending on design choices, it may make sense to record either one). Each bit provided by the data source is stored, bit for bit. If the data source provides data in blocks, the exact contents of a block are stored—also the information to match those contents with their appropriate block number (i.e. the contents of block X need to be known thus the value of X needs to be known). For instance, if the data source returns a 512 byte sector, the identical sequence of 512 bytes is stored in the storage device. Storing such identical bit-for-bit copies of the data in the form provided by the data store ensures that the duplication is a forensically sound replica, which is repeatable, and subject to low level or device forensic analysis.

Often it will be useful to be able to store, transmit, or communicate a map of the disk that was duplicated, identifying properties of different sectors and/or regions (e.g. which sectors/regions are relevant depending upon the granularity that you are looking for). This can be done via a map. A Region Map is a data structure in which: 1. every sector or data on the disk (or every sector or data of concern on the disk) belongs to a known region and 2. a value or an implied value (e.g. enough information to enable the value to be recreated or otherwise determined) is stored for each such region. By way of a non-limiting example, initialize the value for all regions to 0 and examine the sectors in each region. If any sector in a region is determined to be relevant set the value of that region to 1 as that region is determined to be relevant. If no sector in a region is determined to be relevant then the value of that region remains 0. As a result of the fact that any relevant sector in a region makes the region relevant, once a sector is determined to be relevant the remaining sectors in that region need not be examined. Thus, starting with the first sector in the first region, if that sector is relevant skip all remaining sectors in that region and move to the first sector in the next region, if that sector is relevant then set the value of that region to 1 and move to the first sector in the next region. Continue this analysis until all regions (or all regions of concern) are accounted for. If a sector is determined to not be relevant then examine the next sector in that region and continue to do so until a relevant sector is found or all sectors in the region have been examined. Those skilled in the art will recognize that that there are other ways to create a map and still fall within a scope of the below claims. For example, the determination of a relevant region could require more than 1 relevant sector, the value of a region could be based on the number or percentage or relevant sectors within the region. Additionally, when examining sectors, all sectors may be examined, or less than all sectors could be examined in making the determination of whether a region is relevant. Additionally, a Region Map may be created without examining the actual sectors. The methods described above and/or those described in the '410 application may be employed to predict which sectors or regions are relevant. That predicted information may then be stored in the Region Map.

Once the map is established, to query if a particular region is relevant, the value corresponding to that region is examined. If the value is 1 (or some other predetermined value, greater than some predetermined value or less than some predetermined value depending on the design choice of the system), the region is relevant. If the value is 0 (or some other predetermined value, greater than some predetermined value or less than some predetermined value depending on the design choice of the system), the region is irrelevant.

The above described embodiment provides a region map set of 1s and 0s. It is useful to be able to express a region map as such. A set of 1s and 0s can be read, written, and spoken by humans; written down; printed out; and included in documents. As the above described example illustrates, it is possible to create a region map set of 1s and 0s by going through every region in order, and writing a 1 for relevant and 0 for irrelevant. However, this creates a very large set. While not required, it is preferable to make the set more manageable by compressing the region map set then encoding the compressed set into a character encoding. This will represent the binary data as a series of characters. This series of characters may then be stored, displayed, printed transmitted or otherwise utilized and/or stored.

Compression can be done using any conventional lossless compression technique, such as Run Length Limiting (RLL), Lempel-Zev, DEFLATE, gzip, LZ4, etc. Compression techniques may be general purpose, or they may be specifically designed for this domain, or take advantage of properties of this domain. Since region maps tend to have large sets of identical values (e.g. a region that is relevant is usually bordered by other regions that are relevant, and vice versa) Shannon's information theory can be used to compress the region map. A possible, but not the only, compression technique includes:

A. Start with the first region (current region).
B. Determine if the current region is relevant. If so, store a binary 1 in the next RAM bit, otherwise store a binary 0 in the next RAM bit.
C. If relevant, determine how many subsequent regions in a row are relevant. Store this total in X. For example, if the current region is relevant, and the next 3 regions are also relevant, but the fifth region in the series is irrelevant, set X=3.
D. Set Y equal to floor(log base 2(X)).
E. If Y>0: Store Y binary 1s in the next RAM bits. Set X=X−2̂Y. Return to step D.
F. Store a binary 0 in the next RAM bit.
G. Move to the next region that, in step C, was determined to be different (in terms of relevance) than the current region. For example, in the example mentioned in Step C, move to the fifth region. Call this the current region, and return to step B. This process creates a sequence of binary data

Analysis Interface for Selective Storage:

A goal of forensic imaging is to enable collected data to be analyzed, presented, or otherwise read or accessed. Since the image collected and/or stored in accordance with aspects of the invention may be incomplete as compared to the original data source, subsequent data access may need to be modified for the storage device to use partial data. In situations where this is not desirable, the partial data can be presented as complete data using a conventional adapter interface. If the access system tries to access data that has not been collected, the adapter may create an error, indicate that the data was not collected, indicate that the data or data source was bad or corrupt, or return a known dummy value, such as binary zeroes. Likewise, a tool may convert a partial image into a full image, filling in dummy values or indicators of bad data or missing data for locations that were not collected.

Verification of Selective Storage:

Once a conventional forensic image is completed its accuracy may be verified and safety measures may be put into place to ensure that the image is not altered or otherwise tampered with in the future. Typically this involves computing a hash (a relatively short sequence of bits, whose value depends on every bit in the image or the data source) of both the data source and of the image stored on the storage device, then comparing the two. If they match, then the accuracy of the image is verified. This method works with conventional imaging because conventional imaging duplicates the entire drive. Ensuring that the image is not altered or otherwise tampered with in the future involves calculating a hash of the entire image and securely storing the hash for later verification. The integrity of the image can be verified by recalculating the hash and matching it to the existing hash. If the two match, then the image has not been altered.

Since the image collected and/or stored in accordance with aspects of the invention may be incomplete as compared to the original data source, conventional methods for verifying accuracy may need to be modified accordingly. Options for ensuring the integrity of the image include:
1. Computing the hash over the data that was collected, skipping the parts that were not collected;
2. Computing the hash over the data that was collected, inserting known dummy values (such as sequences of zeroes) in place of data that was not collected; and/or,
3. Providing a list of locations or identifiers of data that were collected or not collected (e.g. using a region map). This list can be stored along with a hash.

Alternatively, a hash of this list can be calculated and stored with the image hash. As with conventional verification, the hash can be recomputed to verify the integrity of the image. The hash of the original data source can likewise be calculated using any of the above procedures, and compared to the hash of the image to ensure that the image is an accurate copy. Alternatively, conventional piecewise hashing, and other gap tolerant hashing can be used to verify the selective storage.

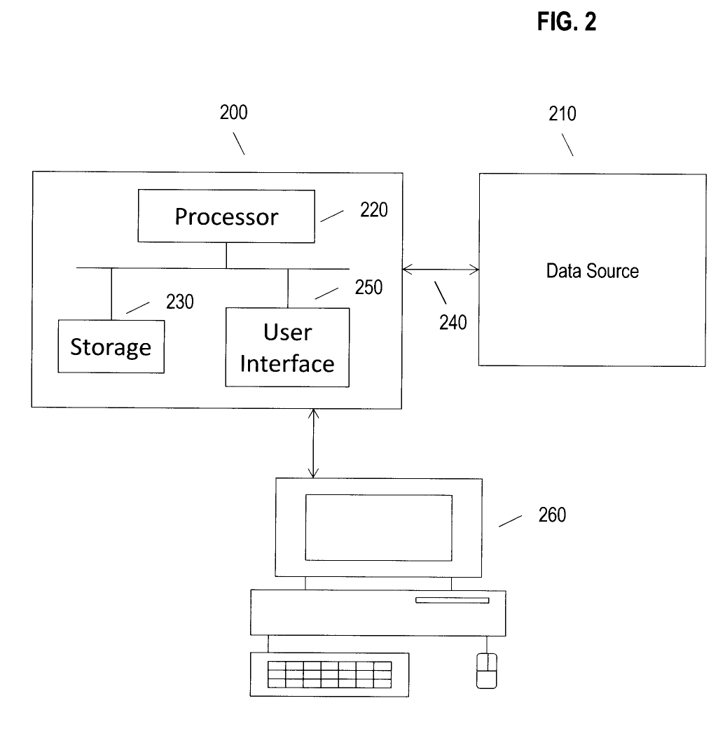

FIG. 2 illustrates an apparatus configured to perform forensically sound imaging in accordance with aspects of the invention. In a preferred embodiment a forensic duplicator, bridge or write blocker 200 is configured to collect and store relevant data from a data source 210 onto a storage device 230. Those skilled in the art will recognize that while FIG. 2 illustrates element 200 connected to computer 260, a forensic duplicator is typically not connected to a computer, while a forensic bridge and write blocker are. However, aspects of the invention may be realized in a software controlled processor on a different device which is connected to the data source via a forensic write blocker with appropriate adapters and connectors, via a network, such as a local area network (LAN), virtual private network (VPN), wide area network (WAN), or the Internet, or via direct hosting of the data source (e.g. downloading software onto the data source or the device controlling the data source and the downloaded software instructing the data source or control device to operate in accordance with aspects of the invention, or inserting a CD or USB drive or other removable media into the device controlling the data source, and booting up onto that CD/USB/media). For ease of explanation the following description will be limited to a modified duplicator 200, however, those skilled in the art will recognize that the description is also applicable to the other embodiments mentioned and one skilled in the art could easily discern from the description how it would apply to other embodiments.

The duplicator 200 may include some or all of the following stored information: the standard location and format of typical volume, partition, and filesystem data and Metadata (including NTFS, FAT, ext2, ext3, ext4, ZFS and other filesystems in use on computers). Data store metadata includes Master Boot Record, partition tables, partition maps, disk label, filesystem metadata, File Allocation Table (FAT), FAT Boot Sector, FAT32 FSINFO, directory files, NTFS Master File Table (MFT), MFT entries, $MFT File, $MFTMirr file, $Boot file, $Volume file, $Bitmap file, directory indexes, filesystem journals, etc. and instructions for how to parse the same, hashing and sampling methods, and hashes, samples, and summaries of data typically found on data sources; data formats and file formats, including instructions for how to parse and analyze such formats, determine characteristics or location of the data or files, and whether they should be expected to be relevant or not; common investigation or usage scenarios and their typical data of interest and the ability to determine if data is likely to be of interest or not—for example, lists of file extensions or folder names and the data typically found in them; and, the ability to configure or create new scenarios or profiles or definitions of relevant data. Additional location and parsers can be loaded onto the device, using a USB interface.

Aspects of the invention provide a Duplicator 200 which stores the following data structures in volatile memory:

A. location_queue:

Stores one or more sector_numbers in a collection;

Provides add(sector_number) operation, which adds a sector_number to the collection;

If the sector_number already exists in the collection, this has no effect, and the collection is not changed;

Provides pop( ) operation, which removes the numerically lowest sector_number from the collection and returns it;

Typically implemented as a red-black tree of sector numbers.

B. Current_sector_number variable:

A memory space capable of storing one sector number

C. Current_sector_data variable:

A memory space capable of storing the data of exactly one sector.

A sector number along with that sector's data is referred to as a sector_package. The current_sector_number along with the current_sector_data is referred to as the current_sector_package.
D. Retrieved_sectors buffer:

Stores one or more sector_packages (that is, a sector number along with the corresponding sector's data).

Typically implemented as two arrays, the first an array of sector numbers and the second an array of sector data.

E. Autodescription_store: This contains memory to store information about the data source, and its volumes, partitions, filesystems, folders, directories, files, and indexes. This information is typically read and parsed from the data source itself. For a NTFS data source, this will store the sector number of the first sector of the NTFS filesystem; the number of bytes per sector; number of sectors per cluster; number of clusters per MFT entry; first Logical Cluster Number (LCN) of the $MFT; first Logical Cluster Number (LCN) of the $MFTMirr; the sector numbers of the sectors that comprise the Master File Table (MFT), $MFT, $MFT $DATA attribute data, $MFTMirr, and $MFTMirr attribute data; and the sector numbers of the sectors making up each MFT entry. For other types of data sources, similarly appropriate type of information is stored. Descriptions of such information, its location, format, and means of parsing it, is well known and thus will not be described further. Those skilled in the art will recognize that these data structures may be stored elsewhere and still fall within a scope of the invention.

The following is a non-limiting example of the operation of an apparatus in accordance with the invention. The apparatus:
1. Reads known locations of the data source, which typically contain metadata describing the data on the source. For example, the first sector of a hard drive typically contains important metadata describing the data on the drive.
2. Copies and stores the data found in these known locations. For each data stored, the original location of the data in the source is stored as well, and associated with the data.
3. Analyzes the contents of the data at these known locations, and uses it to find the location of other metadata of interest.
4. Reads the data at these other locations.
5. Copies and stores such data. For each data stored, the original location of the data in the source is stored as well, and associated with the data.
6. Analyzes such data to find further metadata, repeating steps 3, 4, 5 and 6 any number of times. For example, the NTFS MFT (Master File Table) may be found, copied, and analyzed accordingly.
7. Analyzes part or all of such discovered metadata to find location and characteristics of other data on the source. For instance, the location of all data belonging to deleted files may be found. Or the location of email data may be found. Or the location of audio video file data may be found. Or, the parts of the data source that have never stored data may be identified.
8. Based on such data and analysis, reads additional data from the source expected to be relevant. For instance, it may read all data expected to be email data.
9. Copies and stores such data. For each data stored, the original location of the data in the source is stored as well, and associated with the data. Alternatively, such data may be further analyzed, and only copied and stored if the analysis indicates it relevant. For instance, it may compute a hash of the data, and if the hash matches known good files on the National Software Reference Library (NSRL), the data may be deemed irrelevant and not copied or stored.
10. Optionally copies and stores other data that is referred to by the data read in the preceding steps. For each data stored, metadata including the original location of the data in the source is stored as well, and associated with the data.
11. Optionally copies and stores other data that is in proximity to the data read in the preceding steps. For instance, it may read, copy, and store all data immediately subsequent to certain identified data. For each data stored, metadata including the original location of the data in the source is stored as well, and associated with the data.

Alternatively or in addition to the above, the apparatus may:
1. Determine which sectors are currently, or ever were, allocated or used by the computer. This can be determined by simply assuming the entire range in between the first known used sector and last known used sector was at one point in use, by examining filesystem metadata, by reversing the operating filesystem's allocation algorithm, by searching, by sampling, or by a combination of these.
2. Add these sector numbers to a queue.
3. (Optional) Remove from the queue any sector numbers which are expected to be forensically irrelevant.
4. Collect and image the sector numbers remaining in the queue.
   This second example will collect more data than the first, thus it is more thorough, but as a result it is also slower.

Still another alternative or addition is to group sectors into pages (e.g. 16 MB sectors), as the AFF format already does, and collecting an entire page when any of its sectors are deemed relevant. Each page is either identical to its counterpart in a traditional image, or completely absent. In general, this selective storage may be implemented by using any format that allows inclusion of the sector number of an individual sector or group of sectors and allows omission of some of these sectors or groups of sectors.

Thus it is seen that apparatus and methods are provided for performing a forensic digital investigation. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, but in no way exhaustive, rather than examining the metadata for relevant data, the metadata can be analyzed to find all unused space and then everything that is not unused space could be duplicated. Another non-exhaustive example is that an operator may manually select data to add to the duplication. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described apparatus is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method for performing a forensic investigation of a data source, wherein said data source is divided into a plurality of sectors, wherein said plurality of sectors are allocated according to an order of storage, the method comprising:
a device selectively communicating with the data source;
said device determining that at least one of said plurality of sectors on said data source has been allocated;
said device determining that at least one sector on said data source has never been allocated;
said device identifying as relevant said at least one allocated sector and at least one other of said plurality of sectors which precede, in said order of storage, said at least one allocated sector; and
said device identifying as irrelevant said at least one sector that has never been allocated.

2. The method according to claim 1 further including said device copying, to a storage associated with said device, said at least one allocated sector and said at least one other of said plurality of sectors which precedes, in said order of storage, said at least one allocated sector; and
said device not copying said at least one sector that has never been allocated.

3. The method according to claim 1 wherein said at least one other of said plurality of sectors which precedes, in said order of storage, said at least one allocated sector includes all sectors which precede, in said order of storage, said at least one allocated sector.

4. The method according to claim 1 further comprising said device identifying as relevant at least one sector which immediately follows, in said order of storage, said at least one allocated sector.

5. The method according to claim 1 wherein said at least one allocated sector contains deleted data.

6. The method according to claim 1 further including:
said device defining a subset of at least two of said plurality of sectors as a region, wherein said at least one allocated sector is a member of said subset; and
said device identifying said region as relevant as a result of said determining step.

7. The method according to claim 6 further comprising said device defining another subset of at least two of said plurality of sectors as another region; wherein a metadata is associated with said region and wherein said device determines that no metadata is associated with said another region, said device identifying said another region as relevant as a result of said determination that no metadata is associated with said another region.

8. The method according to claim 1 further comprising a tool examining a plurality of locations on said data source and said device identifying said examined plurality of locations as relevant.

9. The method according to claim 1 further comprising a user interface being employed to examine a plurality of locations on said data source and said device identifying said examined plurality of locations as relevant.

10. The method according to claim 1 further comprising said device defining a subset of at least two of said plurality of sectors as a region, said device defining a subset of at least another two of said plurality of sectors as another region, said device prioritizing a respective relevance of said region and said another region into higher and lower priority regions.

11. A method for performing a forensic investigation of a data source, wherein said data source is divided into a plurality of sectors, wherein said plurality of sectors are allocated according to an order of storage, the method comprising:
a device selectively communicating with the data source;
said device determining that at least one of said plurality of sectors on said data source has been allocated;
said device determining that at least one sector on said data source has never been allocated;
said device copying, to a storage associated with said device, said at least one allocated sector and at least one other of said plurality of sectors which precede, in said order of storage, said at least one allocated sector; and
said device not copying said at least one sector that has never been allocated.

12. The method according to claim 11 wherein said at least one other of said plurality of sectors which precedes, in said order of storage, said at least one allocated sector includes all sectors which precede, in said order of storage, said at least one allocated sector.

13. The method according to claim 12 further comprising said device copying, to said storage associated with said device, at least one sector which immediately follows, in said order of storage, said at least one allocated sector.

14. The Method according to claim 11 wherein said order of storage comprises allocating said plurality of sectors in the storage device in a sequential order.

15. The method according to claim 11 wherein said order of storage comprises sequentially allocating at least some of said plurality of sectors then sequentially allocating at least some more of said plurality of sectors, wherein said at least some of said plurality of sectors and said at least some more of said plurality of sectors are not contiguous.

16. The method according to claim 11 wherein said at least one allocated sector contains a deleted data.

17. The method according to claim 11 further including:
said device defining a subset of at least two of said plurality of sectors as a region, wherein said at least one allocated sector is a member of said subset; and
said device copying said region to said storage as a result of said determining step.

18. The method according to claim 17 further comprising said device defining another subset of at least two of said plurality of sectors as another region; and
said device assigning a value to said region and another value to said another region to create a Region Map.

19. The method according to claim 18 further including said device determining that at least one sector in said another region has been allocated; and wherein said value and said another value are the same value.

20. The method according to claim 18 further including said device determining that said another region includes only sectors which have never been allocated; and
wherein said value and said another value are different values.

21. The method according to claim 18 further comprising said device converting said value and said another value into a set of characters.

22. The method according to claim 17 further comprising said device defining another subset of at least two of said plurality of sectors as another region;
wherein a metadata is associated with said region;
said device determining that no metadata is associated with said another region, said device copying said another region to said storage.

23. The method according to claim 11 wherein said step of determining includes reading data stored in a sector and determining that said read data is relevant data.

24. The method according to claim 11 further comprising subsequent to said device copying, to said storage associated with said device, said at least one allocated sector and said at least one other of said plurality of sectors which precede, in said order of storage, said at least one allocated sector;
said device deleting one of said at least one allocated sector and said at least one other of said plurality of sectors from said storage.

25. The method according to claim 11 further including:
said device defining a subset of at least two of said plurality of sectors as a region, said device determining that each of said at least two of said plurality of sectors has never been allocated; and
said device not copying said region to said storage as a result of said determining step.

26. The method according to claim 25 further comprising said device storing dummy values on said storage for said region.

27. The method according to claim 11 further comprising a tool examining a plurality of locations on said data source and said device copying said plurality of locations to said storage.

28. The method according to claim 11 further comprising a user interface being employed to examine a plurality of locations on said data source and said device copying said plurality of locations to said storage.

29. The method according to claim 11 further comprising said device defining a subset of at least two of said plurality of sectors as a region, said device defining a subset of at least another two of said plurality of sectors as another region, said device prioritizing said region and said another region into higher and lower priority regions.

30. The method according to claim 29 further comprising said device copying said higher priority region prior to copying said lower priority region.

31. A method for performing a forensic investigation of a data source, wherein said data source is divided into a plurality of sectors, wherein said plurality of sectors are allocated according to an order of storage, the method comprising:
a device selectively communicating with the data source;
said device determining that at least one of said plurality of sectors on said data source has been allocated;
said device determining that at least one sector on said data source has never been allocated;
said device identifying as relevant said at least one allocated sector; and
said device identifying as not relevant said at least one sector that has never been allocated.

32. The method according to claim 31 wherein said identifying as relevant includes determining that said allocated sector contains deleted data.

33. The method according to claim 31 wherein said identifying as relevant includes determining that said allocated sector contains current data.

34. The method according to claim 31 further including said device copying, to a storage associated with said device, said at least one allocated sector; and
said device not copying said at least one sector that has never been allocated.

35. An apparatus for performing a forensic investigation of a data source, said data source being divided in a plurality of sectors, wherein said plurality of sectors are allocated according to an order of storage, the apparatus comprising:
a processor configured to selectively communicate with the data source;
said processor configured to determine that at least one of said plurality of sectors on said data source has been allocated;
said processor further configured to determine that at least one sector on said data source has never been allocated;
said processor configured to identify as relevant said at least one allocated sector; and
said processor configured to identify as irrelevant said at least one sector that has never been allocated.
